(19) United States
(12) Patent Application Publication
(10) Pub. No.: US 2021/0084870 A1
(43) Pub. Date: Mar. 25, 2021

(54) SYSTEM AND METHOD FOR CENTRIFUGAL HONEY EXTRACTION

(71) Applicant: Benjamin L. Yost, Kingsley, MI (US)

(72) Inventor: Benjamin L. Yost, Kingsley, MI (US)

(21) Appl. No.: 17/004,701

(22) Filed: Aug. 27, 2020

Related U.S. Application Data
(60) Provisional application No. 62/905,629, filed on Sep. 25, 2019.

(51) Int. Cl. A01K 59/04; A01K 47/02

(52) U.S. Cl. CPC A01K 59/04; A01K 47/02

(57) ABSTRACT

A rotatable frame holder coupled to a Langstroth style rectangular honey frame for spinning honey from the frame into a bucket or similar container. The frame holder comprises a continuous frame holder body with a horizontal channel configured to slidingly mate with a side frame member of the honey frame in a vertical orientation, with a vertical locking engagement with inner edges of the side frame member. The other end of the frame hangs unsupported at a location spaced below the frame holder body. The frame holder includes a drive connection on an upper side, capable of being attached to a rotating drive such as a cordless drill, and the lower unsupported end of the frame can be lowered into a bucket to be spun by the drill.

### RELATED APPLICATIONS/PRIORITY BENEFIT CLAIM

This application claims the benefit of U.S. Provisional Application No. 62/905,629, filed Sep. 25, 2019 by the same inventor (Yost), the entirety of which provisional application is hereby incorporated by reference.

### FIELD

The subject matter of the present application is in the field of honey extractor devices, in particular devices for spinning honey-laden frames from an artificial beehive.

### BACKGROUND

A common type of artificial beehive used by beekeepers is the Langstroth style hive, with removable rectangular frames on which bees build honey-filled wax honeycombs. The honey is typically removed by lifting a frame from the hive box, “capping” or puncturing the wax covering of the cells, mounting the frame in a rotatable frame holder in a bucket or similar container, and then spinning the frame holder in the bucket to centrifugally force the honey out of the frame against the interior of the bucket.

Prior frame holders have a rotatable frame-holding structure that fits into a bucket, with slots or grooves defined in vertically-spaced upper and lower rotating supports between which pairs of frames are mounted lengthwise. The frames are held securely by the supports at both ends while the frame holder is spun inside the bucket. Examples of such prior frame holders are shown in U.S. Pat. Nos. 4,148,733 to Gamble; U.S. Pat. No. 5,433,850 to Murray; and U.S. Pat. No. 6,616,507 to Swaney.

The mechanisms used for spinning the frame holders can vary, but the use of a cordless drill to rotate a drive shaft connected to the frame holder has become commonplace.

Depending on type, prior frame holders can be difficult to clean, mechanically complicated to set up and change out frames, and relatively expensive.

### BRIEF SUMMARY

The present invention is a honey-extracting frame holder that is simple to use, simple to clean, and inexpensive to manufacture. The frame holder comprises a frame holder body defining a horizontal channel having a first open end configured to receive a first end of one “upper” side member of the frame in a sliding fit with a vertical locking engagement, so that the frame hangs freely from the frame holder body in a vertical orientation. The open end of the channel is further configured to abut and stop an outer end of a top member of the frame, which typically projects beyond the side frame members. The opposite or “lower” side member of the frame is unsupported.

In a preferred form, the length of the channel is preferably the same as the length of the side frame member inserted therein, and includes a stop or cap to define a closed end opposite the open end, so that the frame has little or no side-to-side or horizontal play within the channel.

A locking member may be provided in the channel to horizontally lock the side frame member in the frame holder body, for example a lock- or set-screw, a spring detent, or a wedge.

When the honey frame has been assembled to the frame holder, the combination of frame holder and frame is inserted into a bucket or similar container (pail, tub, can, drum, or equivalent) with the lower or free side-member end of the frame unsupported, and the frame holder is rotated at high speed to expel the honey from the frame against the inside of the bucket. After all of the honey is out of the frame, the frame is easily and quickly removed from the frame holder outside the bucket, and a new frame is inserted.

In a further form, the frame holder is combined with a bucket lid or cover having a center bearing that accepts or rotatably mounts the drive shaft connected to the frame holder.

Terms of orientation used herein should be understood as meaning substantially or generally so, rather than exactly, as the exact orientation of the frame holder relative to a bucket will vary with the operator and other environmental factors such as the evenness of supporting surfaces.

These and other features and advantages of the invention will become apparent from the detailed description below, in light of the accompanying drawings.

### BRIEF DESCRIPTION OF THE DRAWINGS

FIG. 1 is an end perspective view of a frame holder and extractor according to the present invention, with a honey frame exploded from the holder.

FIG. 1A is similar to FIG. 1, but shows the frame holder assembled to the honey frame.

FIG. 2 is a side elevation view of the frame holder of FIG. 1, with a honey frame shown in exploded fashion prior to being inserted therein.

FIG. 2A shows the frame holder and the honey frame of FIG. 2 partially assembled.

FIG. 2B shows the frame holder and the honey frame of FIG. 2 fully assembled, with the portion of the honey frame inside the frame holder in hidden lines.

FIG. 2C shows the assembled frame holder and honey frame of FIG. 2, with the frame holder partially sectioned.

FIG. 3 shows the assembled frame holder and honey frame inserted in a bucket and connected to a rotatable driver for spinning the holder and frame in the bucket.

FIG. 4 is similar to FIG. 3, but shows the driver connected to the frame holder through a center opening or bearing in a bucket lid.

### DETAILED DESCRIPTION

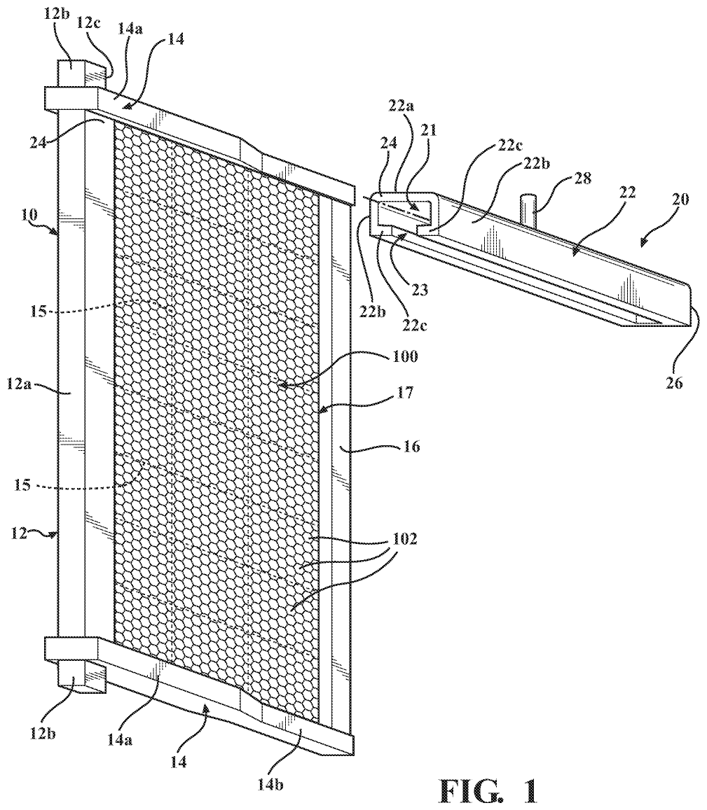

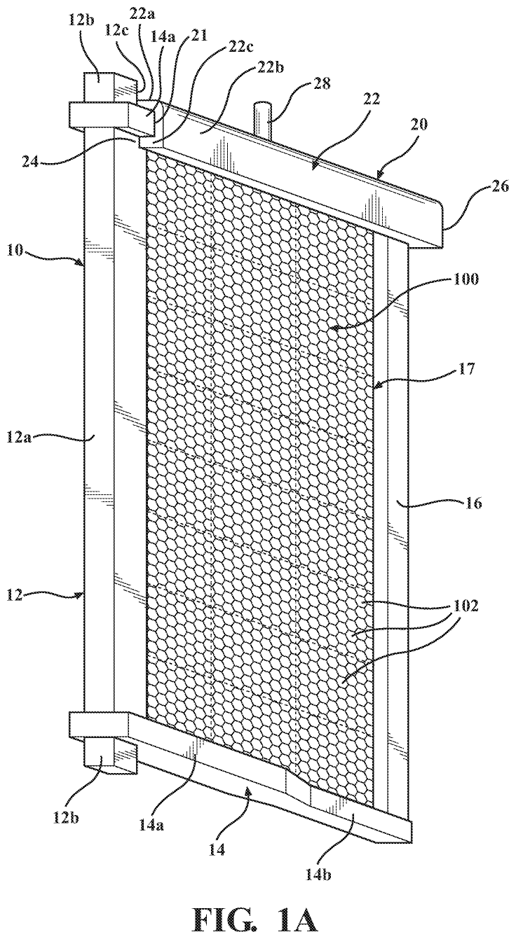

FIG. 1 shows a frame holder 20 according to the invention in exemplary form in order to teach how to make and use the invention. Frame holder 20 is shown in operative association with a honey-collecting frame (honey frame) 10 of known type, used in known manner in a Langstroth style man-made beehive.

Honey frame 10 is rectangular, with a longer and wider main top rail 12 having a main top rail portion 12a and protruding ends 12b; shorter side rails 14 of equal length with wider upper ends 14a and narrower lower ends 14b; and a bottom rail 16 of similar length to main top rail portion 12a extending between sides 14, and with a front-to-back width less than that of main top rail portion 12a and similar to that of the narrower lower portions 14b of the side rails. Top rail 12 typically has outer ends 12b that project beyond side rails 14, enabling it to be mounted horizontally on a rack in a beehive in known manner. Honey frame 10 is typically made of wood, although other materials are believed to be available and/or possible.

Top rail 12, side rails 14, and bottom rail 16 surround and define a generally flat or planar honey-collecting frame area or body 17 between them. Honey-collecting body 17 has a thickness less than the front-to-back width of top rail 12, for example comprising interior honeycomb supports such as a grid of smaller wooden slats 15 on which bees can build a honeycomb 100. Honeycomb 100 comprises a network of honey-containing cells 102 which, prior to a centrifugal honey extraction process, are “capped” or punctured in known manner so that the honey can be spun out of the comb.

The honey frame 10 is generally rectangular, but while the frame rail members are shown with a common rectangular cross-section, other rail cross-sections are believed possible.

Frame holder 20 has a generally tubular frame body 22 of metal or plastic (preferred) although other materials could be used. Body 22 has a top wall 22a, side walls 22b, and spaced, inwardly-facing bottom walls or flanges 22c separated along the length of the frame holder by a longitudinal slot or space 23 that essentially bisects the lower face of the frame holder 20.

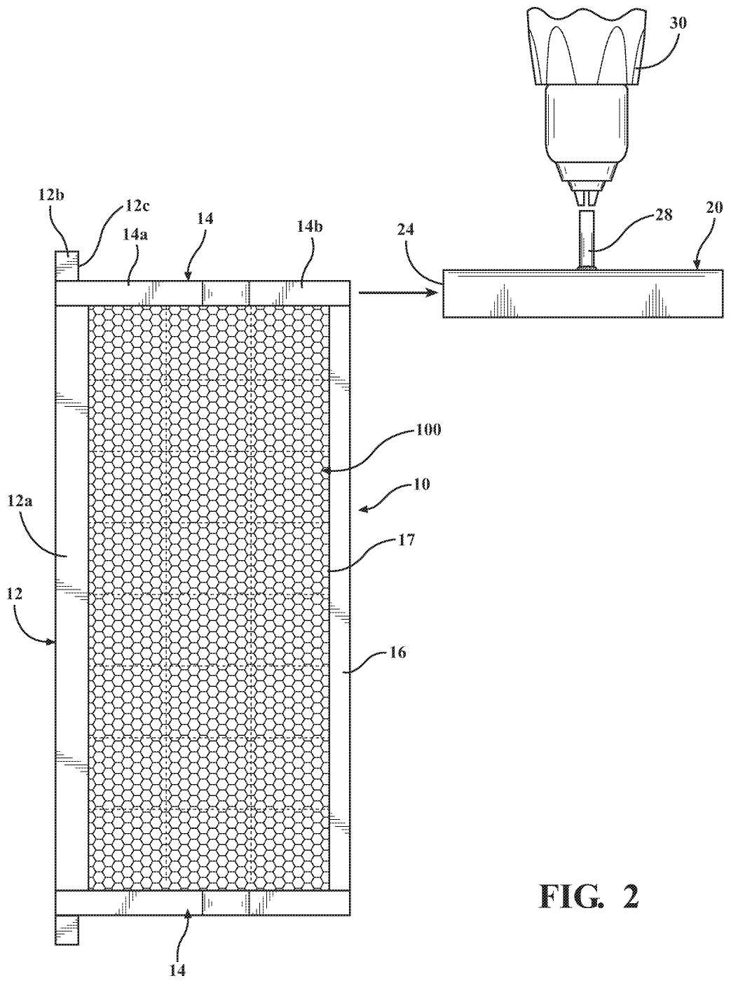

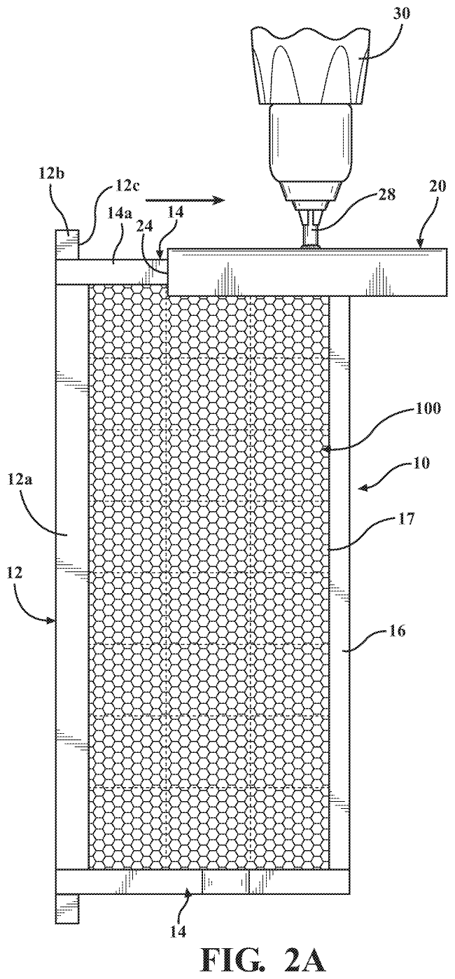

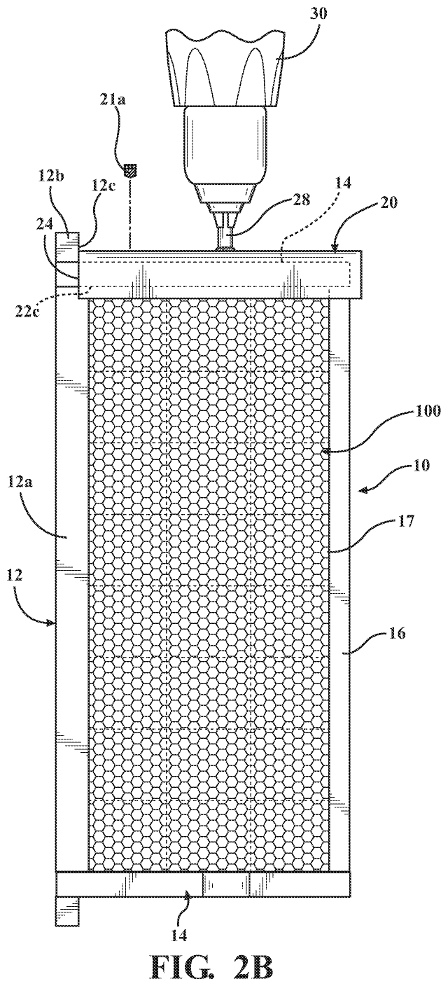

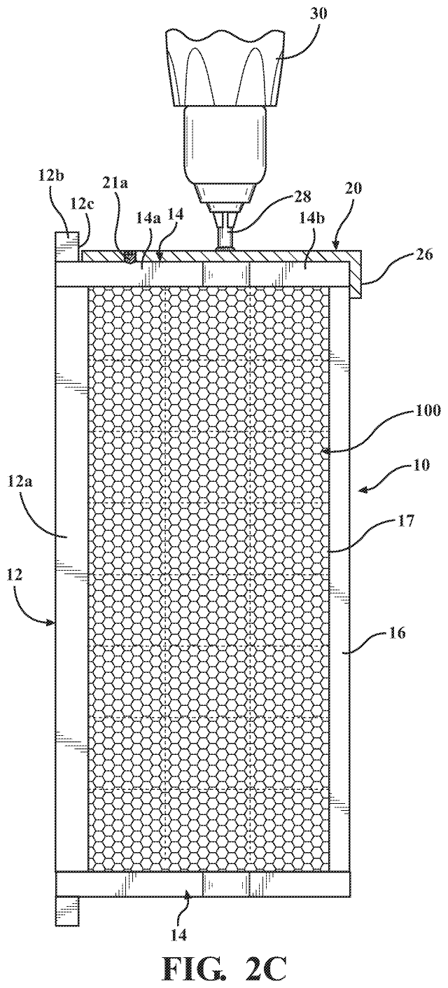

Frame holder body 22 defines an interior horizontal channel 21 sized and shaped to receive one of the side rails 14 via channel open end 24 in a sliding fit, as shown in stages in FIGS. 2-2C. The preferred cross-section configuration of channel 21 substantially matches that of side rails 14, so that the side rail 14 has a close, non-rattling, frictional sliding fit in the channel 21 with some frictional locking effect between at least the wider upper end 14a of the side rail and the interior of the channel. The preferred length of channel 21 substantially matches the length of side rail 14 (including any portion of bottom rail 16 that may be used to calculate the total length of one side 14 of frame 10). So, for example, if the cross-sectional size and shape of wider upper end 14a of side rail 14 is 1-inch by 1-inch, and the length of side rail 14 is eight inches, the dimensions of channel 21 would be approximately 1-inch by 1-inch by eight inches long. It will be understood that the cross-sections of channel 21 and side rail 14 do not need to match in order to have sliding frictional fit; for example, if side rail 14 were circular in cross-section, a square cross-sectional channel 21 would provide a sliding friction fit if the width of channel 21 were substantially equal to the outer diameter of the widest portion of side rail 14. It is also possible to add friction-enhancing structure to the inside surfaces of channel 21 to take up any slop or space between the side rail 14 on the honey frame and the inside of the channel and hold the side rail securely in place, for example where the cross-section of the side rail 14 is a loose fit inside the cross-section of the channel.

Channel 21 has an “inner” open end 24 configured to receive the bottom end of side rail 14 so that the substantially the entire length of side rail 14 can be inserted into channel 21 in frame holder 20. Preferably the channel 21 is long enough to receive the entirety of side rail 14 until the underside 12c of the outer end 12b of top rail 12 stops against the end of frame holder body 22 defining open end 24.

It might be preferable to close or cap the opposite or “outer” end 26 of frame holder body 22 with a stop member to positively limit the longitudinal insertion of side rail 14 through the channel 21 in some circumstances. For example, a cap or cross-bar can be placed across channel 21 as shown at outer end 26 in FIGS. 2B and 2C to prevent further passage of side rail 14, for example where top rail 12 does not have a protruding outer end 12a capable of abutting the open inner end 24.

As seen in hidden lines in FIG. 2B, the inwardly-facing bottom flanges 22c that define the bottom slot 23 in frame holder body 22 form longitudinal shelves for the edges of side rail 14. The width of bottom slot 23 between flanges 22c is wide enough for lower rail 16 and frame body 17 to pass through the slot between the flanges while the edges of the widest portions 14a of side rail 14 slide upon the flanges. Once the side rail 14 has been fully inserted in channel 21, flanges 22c provide vertical locking engagement with side rail 14 via the engagement between the flanges and at least the upper, wider portion 14a of side rail 14. Accordingly, when frame holder 20 is positioned horizontally, with bottom side flanges 22c facing the ground, honey frame 10 hangs vertically from frame holder 20, supported by the “upper” side rail 14 in the frame holder, and with the opposite “lower” side rail 14 hanging free at a location spaced well below the frame holder 20.

As shown in FIG. 2C, frame holder 20 may further include a locking member engageable with side rail 14 in channel 21 to temporarily lock side rail 14 in the channel against horizontal movement. In the illustrated example, an optional locking screw 21a is shown extending through a hole in a wall 22a of the holder body 22 to engage the wooden side rail 14. Alternately, a raised wedge or detent or spring member could be formed on an interior wall in the channel 21 to create a tighter friction fit when the side rail 14 is fully inserted, sufficient to resist horizontal movement of the side rail out of the frame holder when the frame holder 20 is spinning.

Frame holder 20 further includes a rotation drive connection 28 on top wall 22a of frame holder body 22. In the illustrated example, rotation drive connection 28 comprises a fixed vertical shaft projecting upwardly from the frame holder body and configured to be gripped in the chuck of a cordless drill 30 or similar. Rotation drive connection 28 may take other forms, for example recessed connections or other mechanical locking structure provided it is capable of transmitting rotational force from a rotation-imparting device (manual or powered) to the frame holder 20 about a vertical axis through the plane of a honey frame 10 secured in the frame holder.

### Description of Operation

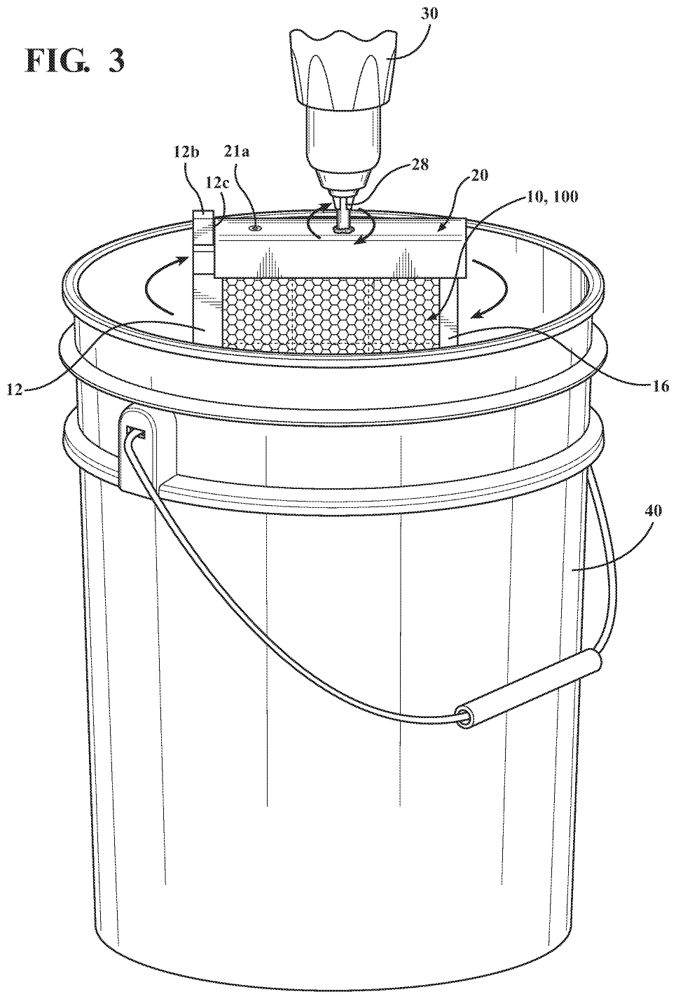

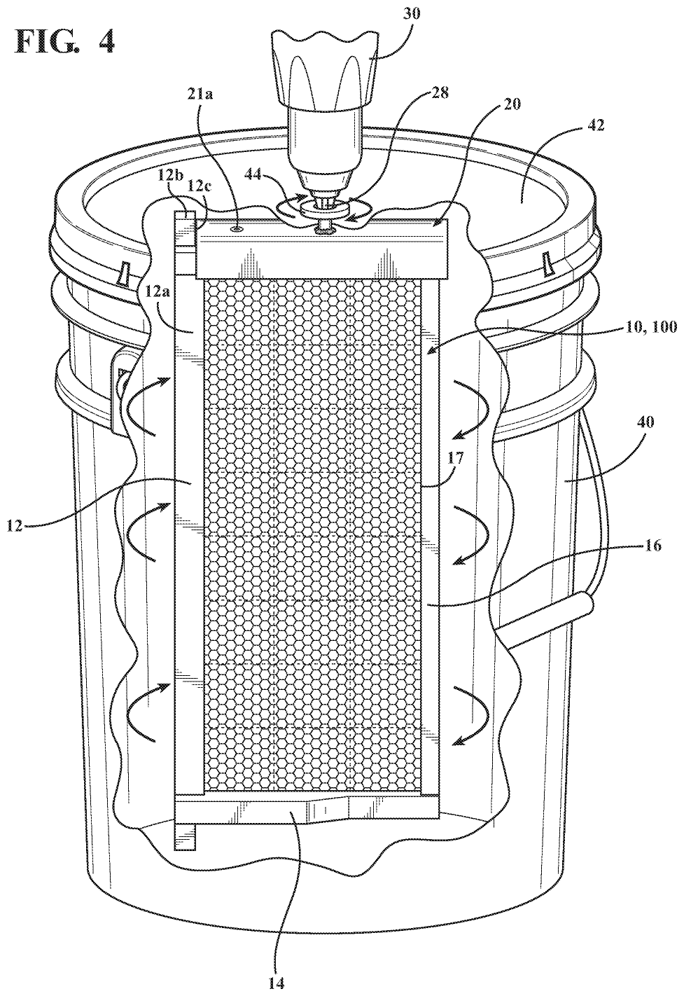

Referring to FIGS. 3 and 4, the frame holder 20 is used by securing a honey frame thereto as described above in FIGS. 1 through 2C, capping the individual honeycomb cells 102 in known manner, and attaching the rotation drive connection 28 to a rotation-imparting device such as drill 30. The lower free end 14 of honey frame is then inserted substantially vertically into a bucket 40 or other type of known, suitable container having a depth equal to or greater than the height of the vertically-oriented honey frame 10, with the lower free end 14 of the honey frame suspended freely above the bottom of the bucket 40. The combined frame holder 20 and honey frame 10 are then spun at relatively high speed to spin the honey out of the honeycomb 100 and into the bucket. In FIG. 4, a lid 42 has been added to the bucket 40 over frame holder 20, with a center bearing or opening 44 through which the drive shaft 28 of the frame holder is rotatably mounted before coupling the shaft to the drill 30.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been used to describe new and useful improvements in science and the useful arts. The scope of the invention supported by the above disclosure should accordingly be construed within the scope of what it teaches and suggests to those skilled in the art, and within the scope of any claims that the above disclosure supports in this application or in any other application claiming priority to this application.

1. A honey-extracting frame holder system comprising:
a. a Langstroth type honey frame;
a frame holder comprising a single continuous frame holder body defining a horizontal channel having a first open end configured to receive a first end of a first upper side member of the honey frame in a sliding fit, the single continuous frame holder body further comprising a rotation drive connection on an upper side of the frame holder body configured to be connected to a source of rotational power;
the horizontal channel comprising inwardly-projecting spaced bottom flanges defining a frame body space between them and having a vertical locking engagement with lower surfaces of the first upper side member of the honey frame when the first upper side member is inserted in the horizontal channel, the frame body space having a width equal to or greater than a width of a planar honey-collecting frame body portion of the honey frame such that the frame body portion extends therethrough; wherein,
the honey frame hangs freely from the frame holder body in a vertical orientation when the first upper side member is inserted in the horizontal channel;
and, wherein,
a second lower side member of the honey frame is spaced from the frame holder in unsupported fashion when the first upper side member is inserted in the horizontal channel.

2. The honey-extracting frame holder system of claim 1, wherein the channel includes a friction member positioned to engage the first upper side member when the first upper side member is fully inserted in the channel, the friction member operable to temporarily secure the first upper side member against horizontal movement in the channel.

3. The honey-extracting frame holder system of claim 1, wherein the horizontal channel has a length substantially equal to a length of the first upper side member, and wherein the single continuous frame holder body comprises a closed end opposite the open end including a stop or cap member engaged by an outer end of the first upper side member when the first upper side member is fully inserted in the horizontal channel.

4. The honey-extracting frame holder system of claim 1, wherein the open end of the horizontal channel is configured to abut and stop an outer end of a top member of the honey frame when the first upper side member is fully inserted in the horizontal channel.

5. A method for extracting honey from a Langstroth style honey frame, the method comprising:
sliding a first end of a first upper side member of the honey frame into an open end of a horizontal channel of a single continuous frame holder body such that lower surfaces of the first upper side member of the honey frame engage inwardly-projecting spaced bottom flanges of the horizontal channel, and further such that a honey-collecting frame body portion of the honey frame extends through a frame body space between the spaced bottom flanges;
positioning the frame holder body horizontally and freely suspending the lower end of the honey frame from the frame holder body vertically while the first upper side member of the honey frame is in the horizontal channel; and,
inserting the freely suspended lower end of the honey frame into a honey-receiving receptacle to a depth corresponding to a length of the vertically suspended honey frame, and spinning the honey frame in the receptacle through the frame holder body with a rotation-imparting driver connected to a rotation drive connection on an upper side of the frame holder body while the lower end of the honey frame is suspended freely in the receptacle above a bottom of the receptacle.
